(19) United States
(12) Patent Application Publication
(10) Pub. No.: US 2002/0103749 A1
(43) Pub. Date: Aug. 1, 2002

(54) Remote on-the-spot credit processing

(76) Inventors: Juan Pablo Agudo, Buenos Aires (AR); Miguel Soulas, Buenos Aires (AR)

Correspondence Address: GODFREY & KAHN S.C., 780 NORTH WATER STREET, MILWAUKEE, WI, 53202, US

(21) Appl. No.: 09/854,913

(22) Filed: May 14, 2001

(30) Foreign Application Priority Data
Dec. 5, 2000 (AR) P000102319

(51) Int. Cl. G06F 17/60

(52) U.S. Cl. 705/38; 705/39; 705/42

(57) ABSTRACT

The processing of credit applications is carried out at two distant sites: a head office with a trained officer and the point of sales without such personnel. The person at the point of sales gathers data on a customer and transmits it to the head office to obtain the credit aptitude of each applicant from a data base of persons inhibited or defaulted and thereafter an analysis and eventual credit grant at the head office. The method scan images to generate files related to the identity of the applicants, documents showing identity and residence and the signature of the respective contracts, replacing or reducing the transfer of papers from one site to another in relation to the conventional system. During the analysis at the head office, the latter calculates and retransmits to the customer a delay time, tipicaly of just a few minutes. The method provides for the computer to control and automatically avoid data being omitted. The data entry may be performed in two stages, the first with the data necessary for checking for defaulters and, once this check is favorable, scanning images of identity documents and invoices to make up the file digital prior to the analysis at the head office. Color coding is used on screen windows to avoid slow applications remaining unattended too long.

### BACKGROUND OF THE INVENTION

The present invention relates to real-time processing of credits on applications originating at sites remote from a credit processing headquarters. More particularly, the invention has application in retailer shops and sites selling articles such as furniture, electrical appliances, vehicles, etc. to enable processing credits on the spot without having personnel highly trained in the art on the site.

From another point of view, the invention enables use of personnel not trained in analysing the credit aptitude for attending the credit applicants and, at the same time, credits to be selectively granted only to those which are properly verified and found to be apt, including checking that they are under no financial inhibition, thereby simplifying consumer access to credits at point of sales sites. From yet another point of view, the invention enables the financial entity to take immediate decisions at the credit headquarters, regardless of the location and size of the point of sales, thereby using its best resources and relying on all the data and full images of documents required for a proper decision, determining that the data is correct and that no fraud is involved, avoiding common process pitfalls and and time inherent to manual stages.

Many countries lack suitable credit bureaus. In such countries, decisions on credit applications rely heavily on document identification, proof of identity, proof of address and proof of income. Placing personnel highly trained in analysis of credit applications at different points of sale associated with a credit entity would entail significant overhead which would make the cost of the credit prohibitive.

A current system processes credit applications on the spot using scantly-trained personnel to review the documents at the point of sales. The system entails sending files of papers to a head-office of the credit entity where credit officers, that is personnel highly trained in credit policy, may analyse the credit aptitude of the applicant. Initially, when the credit application was received at a site remote from the credit entity headquarters, such as a point of sales, the applicant filled in a form provided by an employee generally lacking the same degree of skill as the specially trained personnel. This form was dispatched, inside a file, to the head office for approval thereof. The process is cumbersome, particularly because it takes several days and the current way of carrying it out makes it prone to mistakes. Hence, a first dis-advantage is that the credits are not decided on on the spot, such that the applicant had to return or call several days later for the credit to come into effect and sign the contract if approved.

It often happens that when the credit officer reviews the file at the headquarters, he may not decide the credit first hand because of data which is incomplete or lacking the necessary clarity, for example a defficient photocopy of a document. The file then has to be returned to the remote site to obtain more data or clarify existing data. The cycle repeats until the application is perfected and a decision may be taken on whether to grant of the credit. Thus, several days are wasted which inflates the cost of the credit as well as strains the patience of prospective customers, which has a negative impact on business. Costs increase also due to the physical transfer of files from one place to another and the risk of loss of files because of multiple transfers. A further drawback is bad quality decisions, specially because evident frauds in the papers escape detection, leading to a high degree of defaulters and uncollectables.

Thus, the paper-heavy system outlined above was impractical until the advent of the fax machine over a decade ago which bred a whole new set of business method rules. One such method was for processing credits in such credit-bureau-less and included faxing the documents. Although such a process enabled decisions to be taken in a matter of minutes it was still cumbersome (applications are often incomplete, it being difficult to keep track of which documents had been faxed, requiring reworking and longer turnaround time, and resulting in customer dissatisfaction and lost volume of sales), error-prone (particularly because of missing or illegible documents) and open to fraud (thanks to “disguises” facilitated by the fax), for which reason it is not used in practice. In addition to such pitfalls, associates and customers are not kept informed of the instant status of their credit applications and are uncertain of the time it will take to process each individual application. Uncontrolled time-outs may arise for different reasons such as temporary data or personnel inavailability, resulting in the associate telephoning headquarters under the eye of impatient customers to get status updates. For instance, faxed applications would arrive at headquarters and sit for some time while associate and customer waited at the other site before someone picked them up.

### BRIEF SUMMARY OF THE INVENTION

Therefore, an object of the invention is to provide a method for processing credit applications originating at any number of sites remote from one another and from a head office and which may be decided at the head office in a few minutes, while the applicant waits, with a high degree of reliability.

Another object of the invention is to do away with faxed applications and paper folders by providing web-enabled real-time credit processing with integrated imaging of documents for remote decisions, resulting in faster and quality decisions, more user-friendly processes and better resolution.

A further object of the invention is a credit processing method providing scripts and automated document check-lists for different customer profiles, and moreover automatically impeding the process from proceding until the checklist of documents as a function of a given customer profile is complete, avoiding the above-mentioned pitfalls of faxed applications and enhancing cost, speed and both associate personnel and customer satisfaction.

Yet another object of the invention is to estimate and control credit processing time, instantly providing status and estimate updates and generating alarm signals under predetermined excess-time or status situations, thereby providing optimum customer expectation management, speed, user friendliness, savings in time and telephone calls, and customer and associate personnel satisfaction.

These and other objects and advantages are achieved by a method for processing, on the spot, credit applications at remote sites, which uses a computer program specifically developped to control the execution of the method according to preset specifications thereof with the aid of a computer network linked by a communications means, such as internet, telephone line or dedicated link, in a way that lowly-trained personnel may gather data and documents from customers in multiple points of sale which are transmitted, together with a security check on the credit aptitude of each applicant obtained from a predetermined data base to detect persons with financial histories or inhibited, to a head office where highly trained personnel is responsible for analysing the data and deciding the credits, putting digital files together which are stored in the computer facility in the head office. The method makes effective use of state-of-the-art technology involving a platform of PCs, internet and scanner imaging systems. The scanners are used for generating files related to the identity of the applicants, documents showing income and residence and the signature of the respective contracts.

The responsability for checking and deciding the credit is centralized at a so-called “credit headquarters” manned by trained personnel and having computer systems and data bases storing financial histories of persons.

In essence, the method comprises the stages of: at a remote site, entering personal data of a credit applicant in a terminal and transmit them to the credit headquarters; an officer at the credit headquarters automatically analyses the personal data, including personal inhibitions stored in some data base, and decides the credit application while the applicant waits in the remote site; transmitting the decision to the remote site and generating a computer file with the personal and the credit data, if granted, including imaging of documents proving the identity and address such as identity documents and public works invoices; finally, at the point of sales, the contract bearing the signature of the creditee is imaged and transmitted to the headquarters for filing in the digital file, the applicant immediately enjoying the credit. The stages may be carried out in just a few minutes with reduced probability of mistakes by virtue of the method providing that the computer oversee and prevent data from being omitted.

Real-time pop-up windows may be provided on retailer and headquarter PC screens to signal events requiring attention, such as the arrival of a new application while there is an officer available at the headquarters or to signal a change of status at the POS.

The headquarter screens may display imaged documents and customer profile dependent check-lists side by side to make the credit officers task of checking documents easier, more reliable and quicker.

Terminology

As used herein, “on the spot” means that the person applying for the credit as a rule waits a reasonably short time, on the order of a few minutes, typically less than about twenty minutes, for the credit to be decided on.

As used herein, “credit headquarters” includes a head office of the financial entity eventually granting credits, manned by trained personnel in addition to computer systems and data bases storing financial histories, which may physically reside in the same environment of this office or else at another site which may be accessed via a suitable communications system, such as internet.

A credit applicant is generally an associate or point-of-sale customer, therefore “applicant” and “customer” are thus freely exchangeable in this context.

Likewise, “point of sales (POS)”, associate” and “salesman” are used ex-changeably to mean a site where a customer may use his credit to make an important purchase, by no means limited just to goods but to be interpreted broadly to include services and other consumer benefits.

As used herein, “messages” is used in a broad sense to encompass the transfer of valuable information. It particularly includes e-mail file attachments.

### BRIEF DESCRIPTION OF THE DRAWINGS

FIG. 1 is a schematic block diagram of a hardware system for carrying out the method of the present invention.

FIG. 2A is a flow chart illustrating a sequence of steps of the method for processing credits according to the present invention practised at a point of sales while attending a customer.

FIG. 2B is a flow chart illustrating a sequence of steps of the method for processing credits according to the present invention practised at a head office of the credit entity, while the customer waits at the point of sales.

FIGS. 3, 4A-4B and 5 illustrate screens of a terminal at a remote site where the applicant is being attended.

FIG. 6 illustrates an overall status window opening on the screen of a supervisor terminal.

FIG. 7 illustrates a status window which may be opened to review activity and pendency at a remote-site terminal.

FIG. 8 illustrates a screen appearing on a terminal operated by a credit officer at the credit entity head office to facilitate checking imaged applicant documents.

### DETAILED DESCRIPTION OF A PREFERED EMBODIMENT

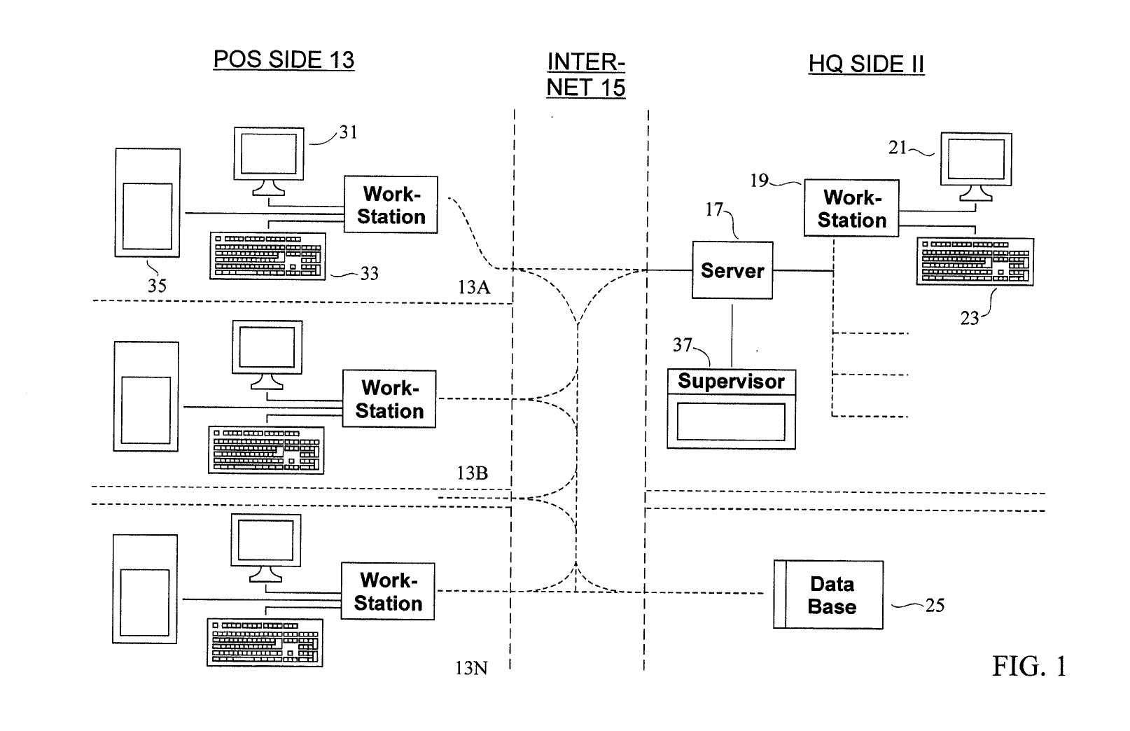

Referring now to FIG. 1, a network system for carrying out the method of the invention is diagrammatically illustrated. The system comprises a credit headquarters side 11 and a remote side comprising a plurality of remote customer sites 13A, 13B . . . . 13N. The remote sides 13 (reference numeral suffices such as “A”, “B” . . . “N” are located at point-of-sales premises geographically distant from the headquarters side 11. A telecommunications network 15 links each of the remote sides 13 to the headquarters side 11.

The headquarters side 11 is equipped with computer means suitable for trained credit officers to review and decide on credit applications received over the network 15, including a server 17 and a plurality of work stations or terminals 19 (of which only one is shown for clarity) for a team of credit officers. Each terminal 19 includes a monitor screen 21 and a keyboard 23 interfacing with a designated officer.

The headquarters side 11 further includes a data-base system 25, such as the known BUREAU VERITAS® base, storing financial histories of people, particularly identity data of defaulters. The data-base 25 is generally an outsourced remote memory resource which may be connected to the server 17 via a private link 29 or directly linked via internet 15 to the remote side terminals 13.

Internet is advantageously used as the telecommunications network 15 and the headquarters server 17 and data-base resource 25 are configured as secure web-sites for password-only access by the remote terminals 13. Of course, use of telephone or private links are also within the purview of the present invention.

Each remote side terminal 13 includes a monitor screen 31, a keyboard 33 and a scanner 35 and is designed to be manned by personnel generally unskilled in credit policy. The system in FIG. 1 is programmed with appropiate computer software for supporting the operations described hereinafter for processing and resolving individual credit applications.

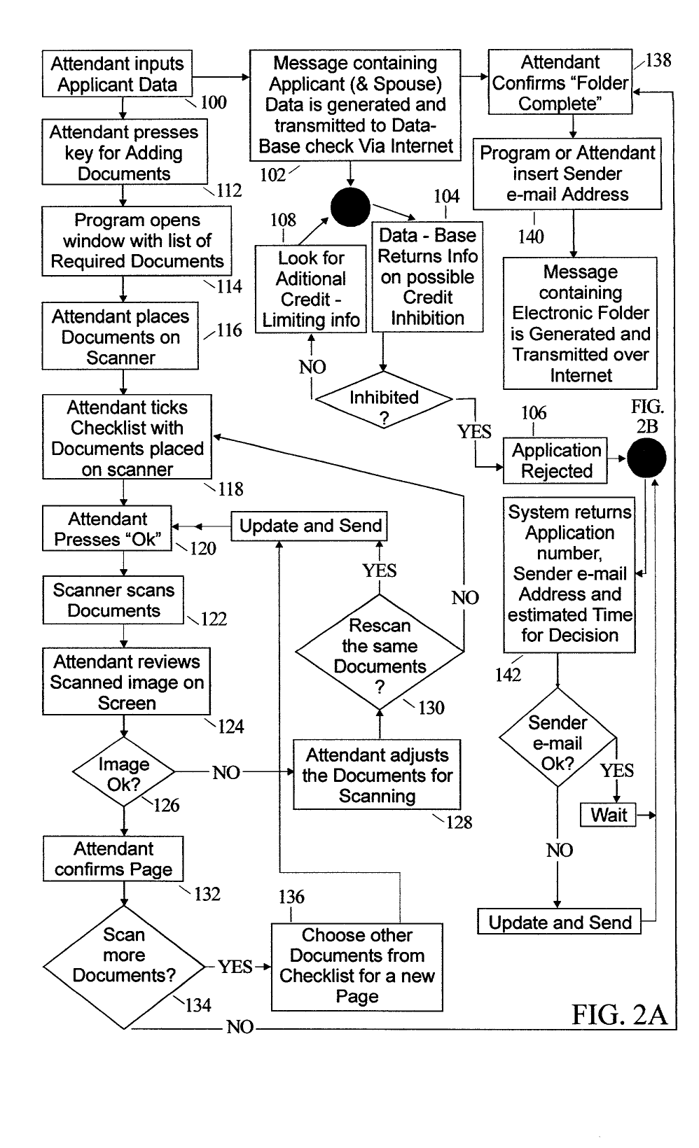

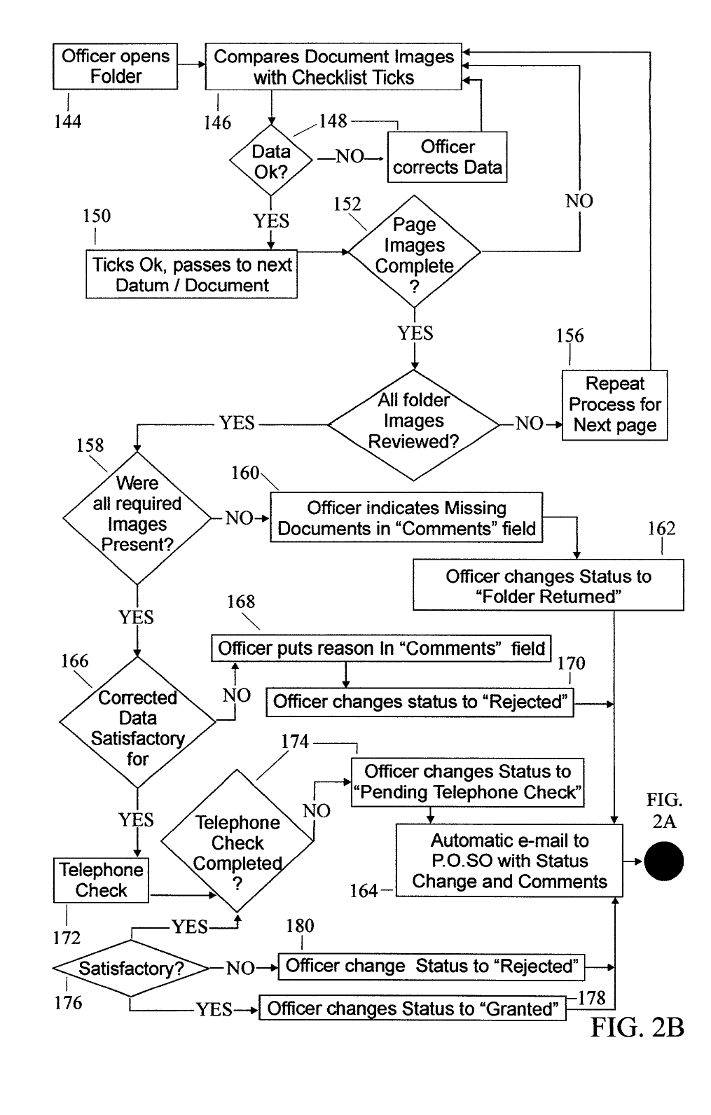

FIGS. 2A and 2B complement each other in that they depict two halves of a single credit operation carried out in accordance with the invention. FIG. 2A corresponds to the method steps associated with attendants physically located at remote points of sales 13 visited by prospective customers, i.e. potential credit applicants. FIG. 2B represents the method steps associated with officers working at the headquarters 11 and specialized in credit policy.

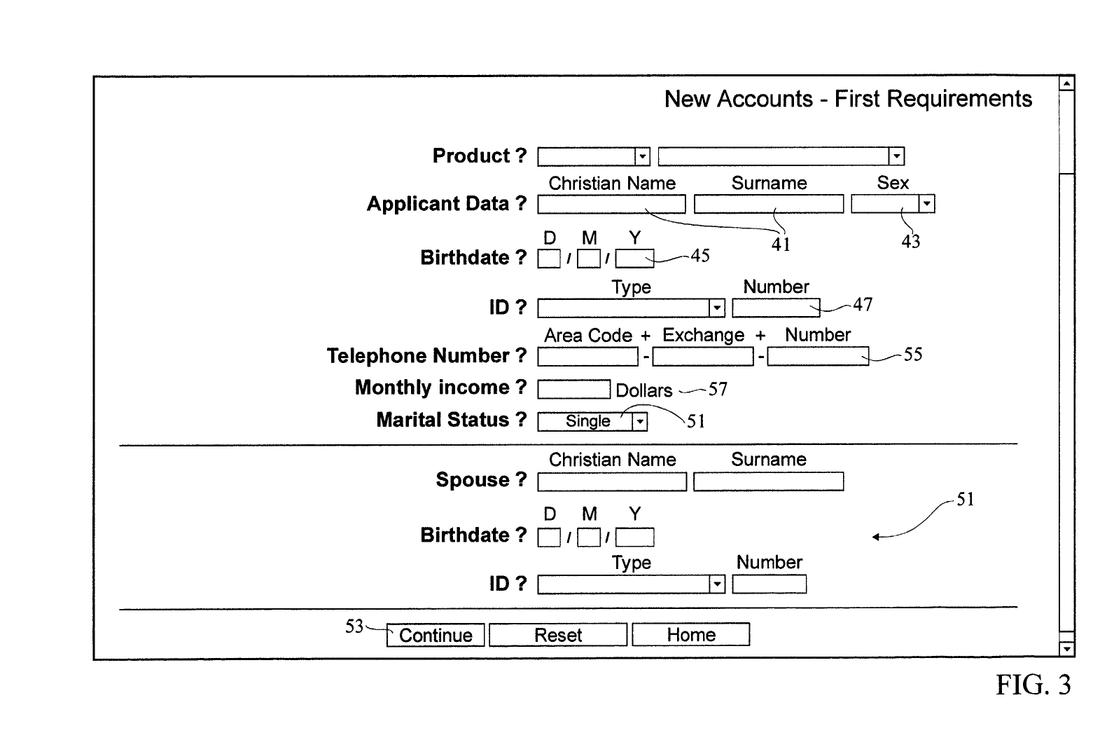

FIG. 3 represents a typical initial screen displayed on a remote-site monitor 31 for the attendant to begin entering the personal data of the applicant (step 100). Once the applicant identity is entered, i.e full name 41, sex 43, birthdate 45 and ID 47, plus like spouse identification 49 if the marital status checkbox 51 is marked as “married”, the attendant pushes a “CONTINUE” button 53 for the program to generate a link to a data base 25 to search whether the applicant or spouse has been reported as defaulted by other entities or is for some reason inhibited from financial operations (step 102). If found therein, the data base 25 returns a message of credit inhibition (step 104) and an automatic decision is conveyed to the remote side 13 rejecting the credit application (step 106), such as in the form of a message saying “SORRY, WE ARE UNABLE TO GIVE YOU CREDIT”. Otherwise, if the applicant is not ihibited outright, information may be gathered on credit amounts pending with other entities (step 108), which may be applied to limit the maximum amount of credit (step 110).

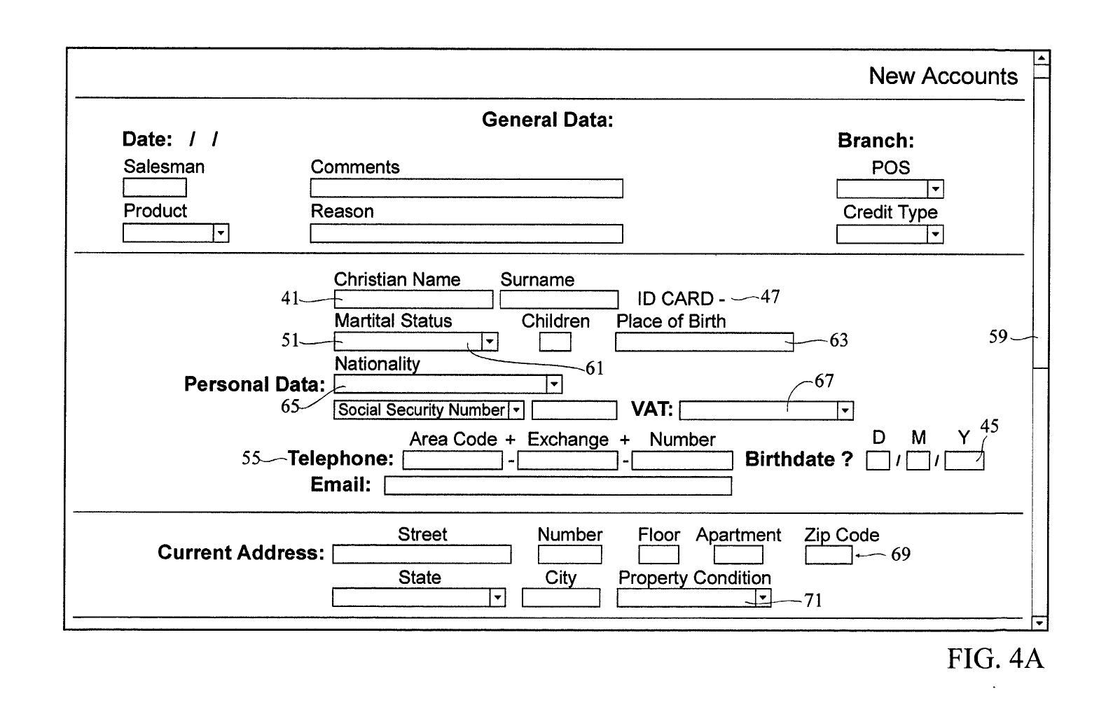

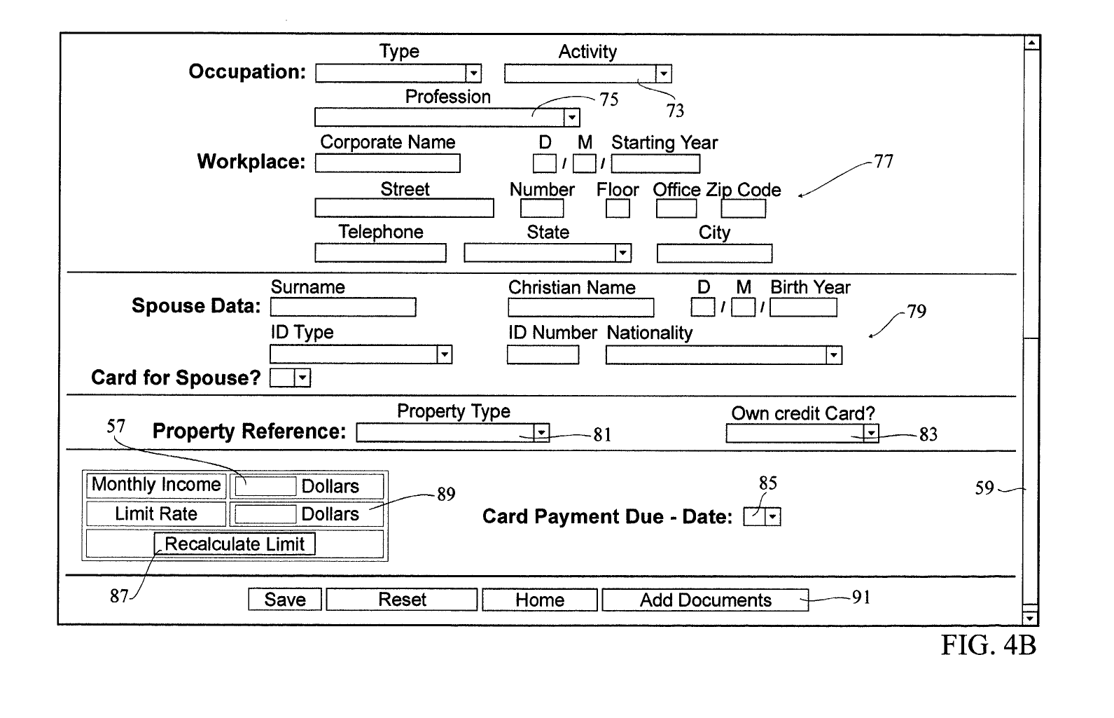

Meanwhile, the attendant may also enter further data in the fields provided in the window in FIG. 3, such as telephone number 55 and monthly income 57. The system proceeds to the window of FIGS. 4A and 4B. FIGS. 4A and 4B refer to a same window but scrolled up and down respectively by sliding button 59 on the side. The attendant may enter herein complementary applicant data, such as number of children 61, birthplace 63, nationality 65, tax code 67, current address 69 and property relationship 71, i.e. whether owner or renting (FIG. 4A). The attendant may then scroll down to enter further applicant data, such as occupation 73, profession 75, is workplace 77, like information on spouse 79, property 81, and an indication of other credit/debit cards 83 and preferred monthly due date 85 (FIG. 4B). Pressing a predetermined window button 87 enables the program to recalculate the credit limit 89 on the basis of the monthly income 57.

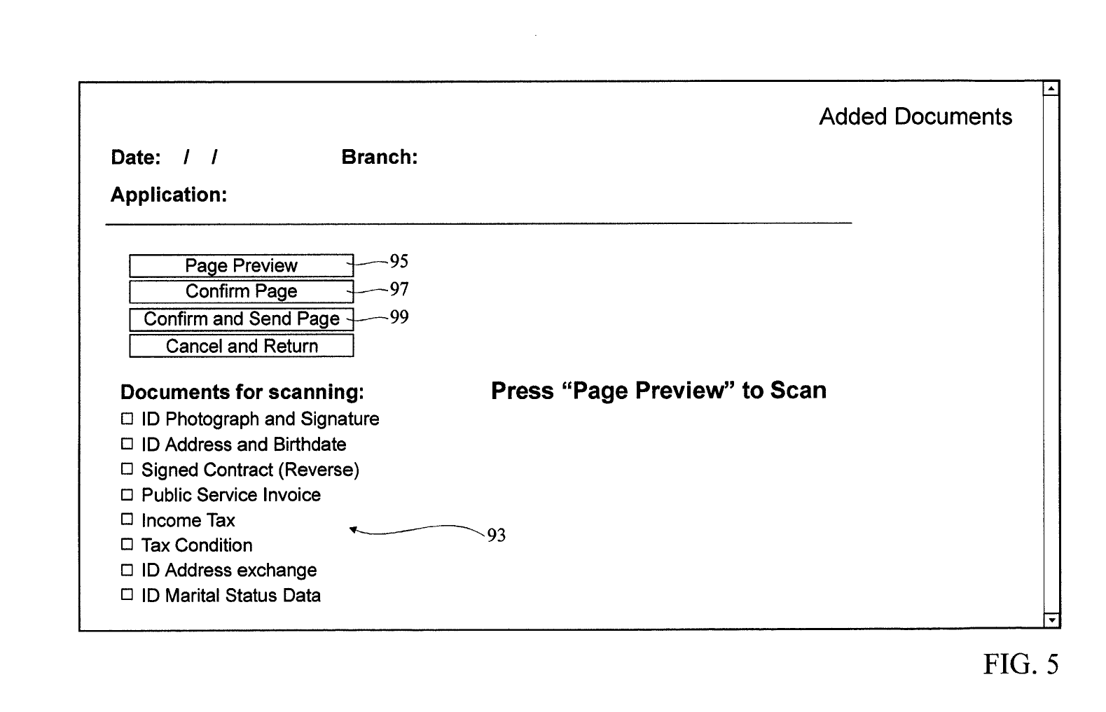

Therafter, the attendant presses a key 91 for adding documents (step 112). A window opens meanwhile on the terminal 31 at the shop, as seen in FIG. 5, showing a checklist of documents 93 to ask the applicant for (step 114). The required documents depend on the customer's profile, for example whether she or he is a staff employee or self-employed or else retired, or whether he already has preapproval of a credit or a bank card of the entity. Table I shows a possible list of documents which are automatically displayed in the form of the checklist 93 depending on the applicant's profile.

TABLE I

| Profile: | Documents: |
|---|---|
| Staff employee: | Identity card: photo and signature |
| | Identity card: address and birthdate |
| | Salary receipt |
| | Public service invoice |
| | Social security card |
| | Identity card: change of address |
| | Identity card: marital status data |
| Self-employed: | Identity card: photo and signature |
| | Identity card: address and birthdate |
| | Social security card |
| | Tax declaration |
| | Service invoice |
| | Identity card: change of address |
| | Identity card: marital status data |
| Retired (pensioner): | Identity card: photo and signature |
| | Identity card: address and birthdate |
| | Social security card |
| | Pension receipt |
| | Service invoice |
| | Identity card: change of address |
| | Identity card: marital status data |
| Preapproved credit or bank card: | Identity card: photo and signature |
| | Identity card: address and birthdate |
| | Credit or bank card |
| | Identity card: change of address |
| | Identity card: marital status data |

The attendant then places some of the documents 93, for example identity card and service invoices or other suitable instruments to establish identity and residence, on the scanner glass 35 (step 116), ticks off the list 93 the type of documents about to be scanned (step 118) and presses the ENTER key (step 120) on the keyboard 33. The attendant may place one of the checklisted documents or preferably more as the size of the scanner glass 35 permits. The scanner 35 images the personal documents (step 122) while the attendant views the generated image on a window in her or his screen 31 by pressing window button 95 (step 124). Once the scan is over, the attendant is required to okay the image (query 126—window button 97), since it is possible that the documents may have been placed upside-down, overlapping, folded, etc., in which case the attendant should readjust the documents on the glass 35 (step 128) and then scan the same documents again, whereafter query 130 returns to step 120. If or once the documents are properly scanned, the attendant proceeds with other documents on the mandatory checklist 93, for example the reverse side of the ID card, in which case it returns to step 118.

The page is confirmed when the attendant responds YES to program prompt 126 (step 132—window button 99). The program automatically checks whether unselected documents remain on the checklist 93 (query 134), in which case the attendant is returned to step 116 to prepare a new page (step 136). After completing the cycle again, the attendant signals that the file is complete on the screen of her or his terminal (steps 138) whereafter the file is transmitted to the head office together with the sender's e-mail address which is automatically appended for directing further on a response containing the credit decision. The electronic file is transmitted over the internet link 15 to the head office 11 (step 140), whereafter the process proceeds per the flow chart of FIG. 2B.

The server 17 at the headquarters 11 directs the incoming electronic file to the terminal 19 of an available specialized officers trained in credit policy. If all are busy, the filed is queued on a FIFO (first in is first out) basis. According to how busy they are, there may be a few minutes wait. The program in the server 17 includes an algorithm to dynamically estimate the delay T as a function of the actual speed in which applications are being handled by the team of credit officers. A suitable algorithm is 1.5 times the time the senior application has been waiting in the queue plus an estimated average analysis time, e.g. 15 minutes.

The credit application is allotted a serial number N which is packaged together with the estimated delay T into a return message sent back over the link 15 to the e-mail address provided in the step 138 (step 142). This information is displayed in a window together with a field 153 specifying the status of the process, in a format such as:

| File Number | Status | Delay |
|---|---|---|
| N | QUEUED/ANALYSIS | T |

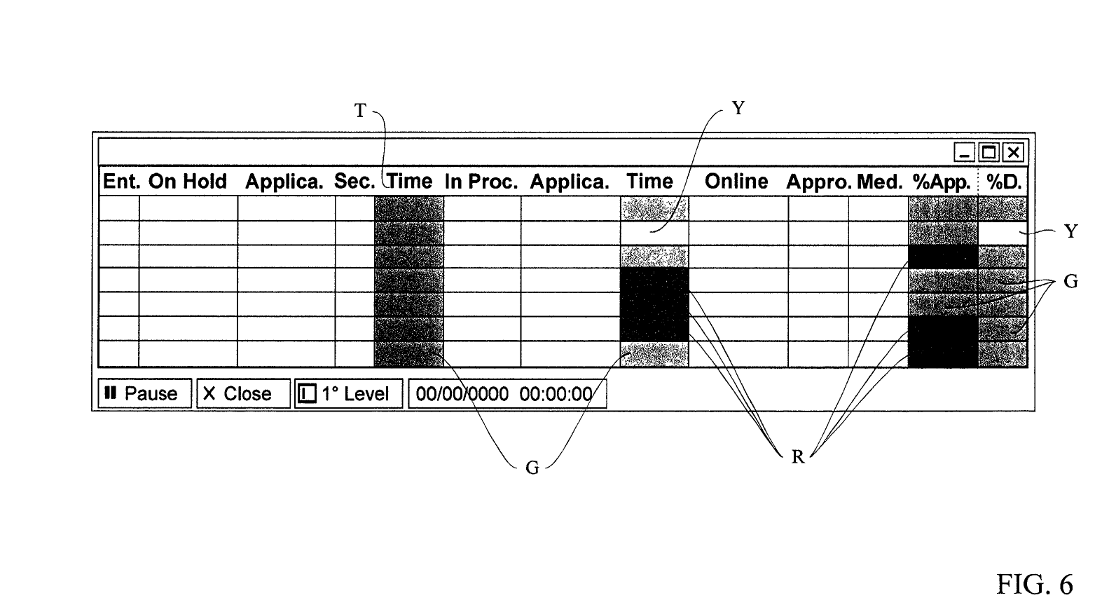

Furthermore, the individual time t each application with a pending decision, whether currently assigned to a credit officer or in the queue, is taking to be processed, i.e. until a final acceptance or rejection decision is conveyed to the originating terminal 13, is regularly updated and compared against one or more threshholds. A supervisor 37 at the head office 11 is connected to the server 17 and may maximize a status table programmed in Visual Basic to view the status of pending applications. See FIG. 6. Each row contains application data of a different pending application, indicating the time t elapsed since the application was queued and the current status. The table is regularly refreshed, i.e. updated. The table enables the super-visor to view at any moment the applications queued, the applications under analysis, the expected processing time, the average processing time and the time of the oldest application pending a final decision.

The table includes colour codes for signalling application times exceding preset threshholds. A green background G of a cell of the table means that the analysis time t of the application of that row is normal. A first threshhold t₁ may represent a time exceding 50% of the average analysis time, generating a first alarm causing the background of a cell viewing status data of a credit application exceding this threshhold to turn yellow Y. A second alarm threshhold t₂ may represent a time far too long for analysis time, causing the background of a cell viewing status data of a credit application exceding this threshhold to turn red R, signalling immediate attention. As soon as this happens, that is an application status “goes red”, the table window is automatically maximized on the supervisor terminal 37. The alarm includes a sound such as a bell to call attetion to the maximized window.

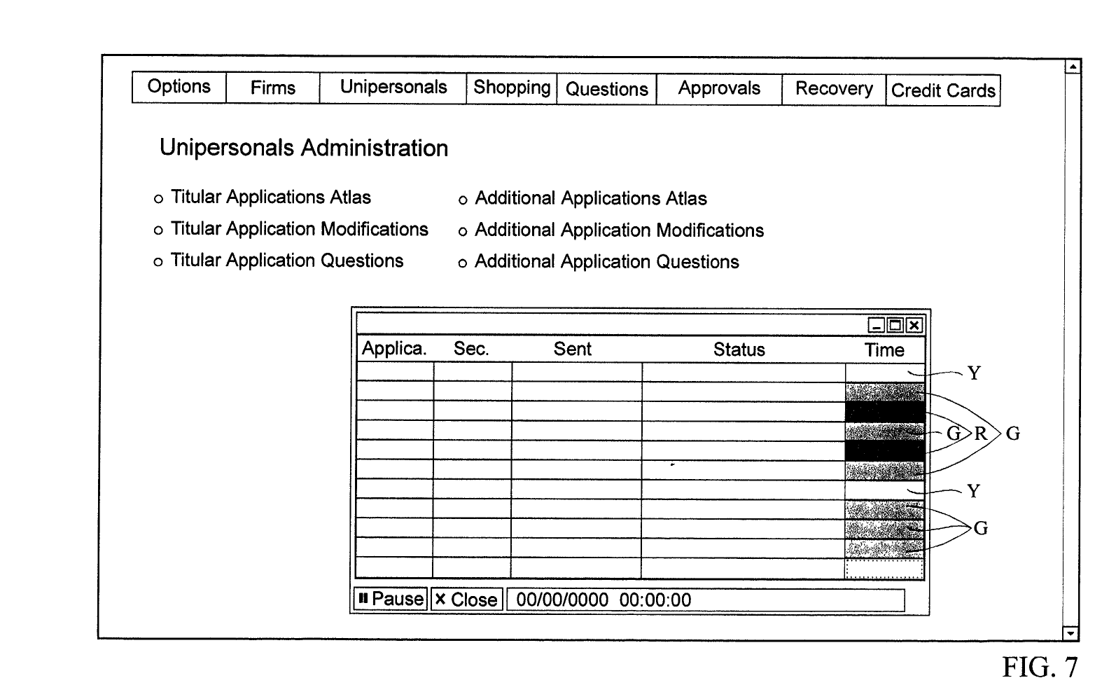

The status information of each application is also regularly refreshed at their corresponding originating terminals 31, enabling attendants to know the status of each application on which he has an applicant waiting. FIG. 7 shows a window which the attendant may open on his terminal 31, . Colour codes G, Y and R are used in a similar manner so that the attendant is alerted to overdues, so that the attendant may inform the applicant and maintain a good customer relationship even if an application is slow for some reason. For the same reason, a window is maximized immediately on terminal 31 as soon as a return message is received from headquarters 11 with a final decision to grant or reject the application, for the attendant to act swiftly as outlined hereinafter.

FIG. 2B outlines the method followed at the headquarters as soon a credit officer receives an application on his terminal 19 from the server 17. This will usualy be the senior application in the queue. The change of status is automatically messaged by the program software over the link 15 to the originating attendant and the corresponding status window field 153 switches from “QUEUED” to “ANALYSIS”. Of course, applications may bypass the queue if not all officers are busy.

The officer opens the file and starts to analyse the credit application (step 144), checking that the scanned documents match those marked up on the list (step 146), eventually correcting mistakes detected by marking the correct field (steps 148).

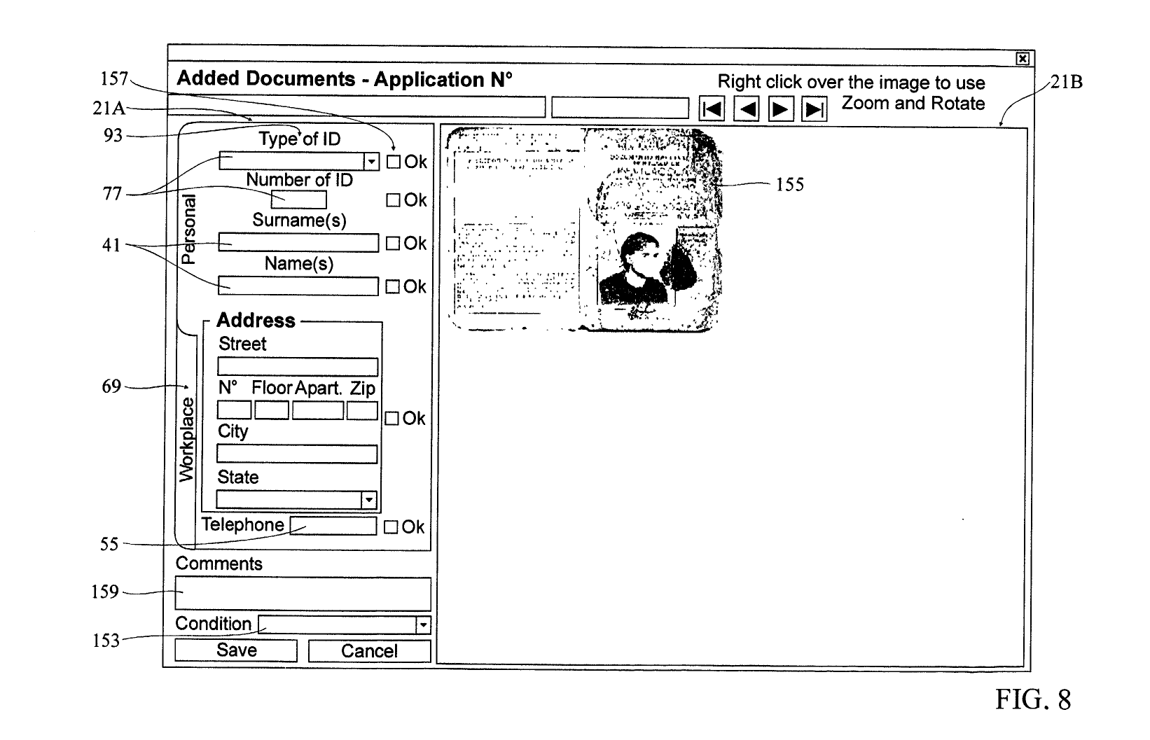

Once all items are checked, the officer presses a key 23′ on her or his keyboard 23 to call the imaged documents. The program displays the documents 155 and the corresponding checklist 93 simultaneously via split windows 217A, 21B on the screen 21, as shown in FIG. 8. The checklist 93 is the same one generated earlier on the POS side 13 according to the applicant profile as listed in Table 1 hereinabove. The officer ticks off the type of document 155 (an ID card in the case illustrated in FIG. 8) in the boxes 157 provided on the checklist 93. The officer particularly scrutinizes identity documents for evidence of fraud on the displayed document, such as smudged or unmatched seals or replaced photograph. The image may be zoomed and rotated for better scrutiny. The officer presses key 23′ on her or his keyboard 23 to switch to the next document (step 150).

The resident head-office program checks whether the imaging on the screen is complete (check 152) and that all images in the file were displayed (check 154), i.e. that all checkboxes 157 were ticked off, the routine returning to step 146 in the negative (step 156).

The officer then checks that all the images 151 were present (step 158). If not, the officer indicates what is missing in a remarks field 159 (step 60) and switches the field 153 to a FILE RETURNED status (step 62), which is displayed on the terminal 31 at the point of sales as soon as a corresponding message is received from the head office 11 (step 64). The process goes back to the point of sales terminal for the attendant to complete the missing items, as disclosed in relation to FIG. 2A.

The officer also checks that the corrected data are satisfactory (step 166) for the credit. The step 166 includes checking the telephone number(s) in an electronic telephone directory, in particular the office or workplace telephone and putting in a telephone call thereto verify that the applicant is still employed there.

If either of these checks fails, the application is considerd suspect and rejected. The officer specifies the reason therefor in the remarks field 159 (step 168) and switches the status 153 to REJECTED (step 170), the program generating the corresponding message which is transmitted to the point of sales terminal (step 164).

Hence, the correct integration of the credit application file is in the hands of the credit officer, that is trained personnel. Mistakes which are unavoidable in the long run on the part of attendants or salesmen are corrected and the effects of such mistakes are reduced. The supervisor screen illustrated in FIG. 6 provides statistical data on percentage of applications granted, rejected and returned in addition to number of appliactions processed and average processing time, using the same colour coding to pinpoint areas exceding predetermined thressholds.

Back again to the salesman's terminal (FIG. 7), in the event of GRANTED (step 178), a contract document is generated and printed for the applicant to sign, becoming thereby enabled to use the credit. This document may be scanned and added to the electronic file filed in a storage means of the head office network. A card or a temporary credit letter may be printed for the customer to go to a counter and make his purchase.

While the invention has been described with reference to a preferred embodiment, it will be understood by those skiled in the art that various changes may be made and equivalents may be substituted for elements thereof without departing from the scope of the invention. In addition, many modifications may be made to adapt a particular situation or step to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

We claim:

1. A method for on-the-spot processing of credit applications at at least one site remote from a credit headquarters, said method using human resources at said headquarters and comprising the stages of:
(a) entering personal data of a credit applicant at a remote site;
(b) transmitting the entered personal data of a credit applicant at a remote site to the credit headquarters;
(c) analysing said personal data at said credit headquarters and deciding the credit application while the applicant is substantially at the remote site; and
(d) thereafter transmitting the decision to the remote site and generating a computer file with the personal data and credit data, said computer file including at least one scanned image;
(e) storing said computer file in a computer storage means in said credit headquarters.

2. A method according to claim 1, wherein said step (a) of entering data includes scanning at least part of an identity document of the applicant to obtain a document image and storing said image in a file of the terminal.

3. A method according to claim 1, wherein said stages (a) a (d) comprise the steps of:
(i) entering personal data of a credit applicant and storing the same in a computer terminal at a remote site;
(ii) using a program to check whether the stored data fulfill a predetermined list of data requirements sufficient, at least, for checking the credit aptitude and eventually display a message on a terminal screen in the event data is missing;
(iii) eventually repeating the preceding steps until said list of requirements is complete;
(iv) generating, in response to said check being successful, a credit application message with the stored data and images and transmit the same from the terminal at said remote site to said credit headquarters;
(v) checking, at said credit headquarters, the aptitude of the applicant for the credit and decide on the grant or rejection of the credit as a function of said check;
(vi) transmitting a message to said terminal at the remote site with information on said decision on the credit and
(vii) in case of a decision to grant, generating and printing a contract document at the terminal for the applicant to sign.

4. A method according to claim 3, wherein said step (i) of entering data includes entering in the identification of the applicant and scanning at least part of an identity document of the applicant to obtain a document image and storing said image in a file of the terminal in association with said identification data.

5. A method according to claim 4, wherein said step (i) includes displaying a multiple-choice menu of applicat activity profiles selecting an applicant profile from said multiple-choice menu, and said step (ii) includes using said selected profile for selecting and displaying a checklist from a plurality of predetermined checklists of documents required for imaging.

6. A method according to claim 5, wherein said multiple-choice profile menu includes employee, self-employed, retired or bank-cardholder.

7. A method according to claim 5, wherein said program executes step (iii) to return to step (ii) in response to detecting an incomplete selected checklist, thereby only enabling proceding to said step (iv) of generating said credit application message in response to a complete selected checklist.

8. A method according to claim 5, wherein said checking step (v) includes checking each scanned document against said selected profile-dependent checklist and returning to step (ii) in response to finding at least one scanned document not matching said selected checklist.

9. A method according to claim 8, wherein said checking step (v) further includes displaying said selected profile-dependent checklist and said scanned document at the same time in side-by-side split windows of a headquarter terminal screen.

10. A method according to claim 8, wherein said checking step (v) further precludes said step (vi) from transmitting a message conveying a decision to grant said credit until said selected profile-dependent checklist of scanned document is completed at said headquarter terminal screen.

11. A method according to claim 5, wherein said checking step (v) includes viewing each scanned document to look for evidence of fraud or tampering.

12. A method according to claim 3, further comprising the additional steps of: (viii) scanning said contract document to obtain an image thereof and (ix) transmitting this image in a file of the terminal.

13. A method according to claim 3, wherein the step (v) of checking the aptitude comprises looking up a data base of persons inhibited from financial operations, using personal data of the applicant to determine whether the applicant is inhibited from financial operations and generating a message of aptitude for said credit according to said determination of inhibition.

14. A method according to claim 13, wherein said data base is external to said credit headquarters.

15. A method according to claim 13, wherein said step (i) of entering data comprises typing minimum data of identification of the applicant necessary for checking the credit aptitude and in said step (vii) entering the remainding data of the applicant to complete the required data lista in the event said credit is granted.

16. A method according to claim 3, wherein said step (vii) further includes printing a card or a temporary credit letter at the remote site including credit amount.

17. A method according to claim 3, wherein said step (vii) further includes printing a welcome letter.

18. A method according to claim 1, wherein said stages (a) to (d) comprise the steps of:
(i) entering personal data of a credit applicant at a computer terminal in a remote site according to a predetermined list of data requirements sufficient for a check on credit aptitude;
(ii) obtaining, by means of a communication between servers with a data base of persons inhibited from financial operations, information from said data base on whether said personal data of the applicant is linked to a person which has been inhibited from financial operationsand for said credit;
(iii) in case of inhibition, rejecting and terminating the processing of the credit application;
(iv) in case of no inhibition, continuing with the processing of the credit application by completing the entry of personal data of the applicant and scanning at least part of an identity document of the applicant to obtain a document image and storing said image in a file of the terminal in association with said identification data;
(v) generating a credit application message with the stored data and images and transmitting the same from the terminal at said remote site to said credit headquarters;
(vi) checking at said credit headquarters the aptitude of the applicant for the credit and deciding the credit application whether to grant the credit as a function of said check;
(vii) transmitting from said credit headquarters to said terminal of the remote site a message with information on said decision on the credit;
(viii) generating a document on credit conditions at the terminal;
(ix) having the applicant sign said document on credit conditions;
(x) scanning said document on credit conditions signed by the applicant at the remote site;
(xi) creating a digital file with the personal data of the applicant and the scanned images and thereafter transmititting the same to a storage means at said credit headquarters.

19. A method according to claim 1, wherein said remote site is a point of sales.

20. A method according to claim 1, wherein upon finishing said stage (b) of transmitting, said credit headquarters retransmits to said remote site an estimated time for completing said stage (c) of analysing and deciding, which is calculated as a function of predetermined parameters including the quantity of credit applications under analysis.

21. A method according to claim 1, further comprising counting time elapsed from the start of said stage (b) of transmitting to the headquarters and until said stage (d) of transmitting back to the remote site.

22. A method according to claim 21, wherein said stage (c) further includes displaying said elapsed time on a computer terminal at a remote site.

23. A method according to claim 22, wherein said stage (c) further includes displaying said elapsed time on said computer terminal at a remote site using at least two different colour codes depending on predetermined elapsed time threshholds.

24. A method according to claim 21, further including displaying an alarm window on a computer terminal at said headquarters in response to said elapsed time exceding a predetermined threshhold.

25. A method according to claim 24, wherein said alarm window display comprises maximizing a window on said headquarter computer terminal, said maximized window including message and remote site identification data.

26. A method according to claim 21, wherein said elapsed time does not exceed twenty minutes in at least 99% of the cases.

27. A method according to claim 1, wherein said stage (c) said analysis comprises checking whether the customer has not been reported as defaulted in debt repayment by other entities and credit ammounts with others entities and the said decision includes setting a limit to the credit to be granted as a function of the existence of said credit amounts.

28 A method according to claim 1, wherein said transmissions between the credit headquarters and the remote site are channelled via internet.

29. A method according to claim 28, further comprising providing a web-site at said credit headquarters and wherein said transmissions from the remote site are channelled to said web-site.

30. A system for real-time processing of credit applications using means and human resources at a credit headquarters and a plurality of sales sites generally remote from said headquarters, said system means and comprising:
computer terminal means at each sales site, said computer terminal means including a printer, a monitor screen and a keyboard for an operator at said sales site to enter personal data of a credit applicant, said personal data including an identity and a profile defining a profession or professional activity of said credit applicant,
scanner means at each sales site for obtaing and storing images of personal documents provided by said credit applicant,
memory means for storing a plurality of predetermined checklists of applicant documents required to be scanned as a function of predetermied applicant profiles
program means for using said entered applicant profile to select one of said checklist from said plurality of checklists and displaying the selected checklist on said sales-site screen for said operator to tick each required document as the document is imaged,
telecommunications means for transmitting forward messages containing said entered personal data and images of said scanned documents to said headquarters,
program means for inhibitting said telecommunications means from transmitting said forward messages in response to any one tick missing on said checklist,
computer terminal means at said headquarters linked to said telecommunications means for receiving said forward messages from said remote sales-site computer terminal means, said headquarters computer terminal means including a monitor screen for displaying said checklist and each imaged document contained in said forward message and a keyboard for a trained credit officer at said headquarters to view each displayed imaged document and tick it off said checklist,
program means for generating a return message upon said officer completing all ticks on said checklist and rendering a decision to one of approving, rejecting, limitting or withholding said credit application, said telecommunications means transmitting said return message to computer terminal means at the site from which said forward message was trasmitted, and
program means for receiving said return message at said sales-site computer terminal means and enabling said sales-site printer to print a card or voucher with credit amount information in response to said return message containing an approval decision.

31. A system according to claim 30, further comprising program means for estimating a processing time in response to said telecommunications means transmitting said forward message to said headquarters and displaying said time on said sales-site monitor screen.

32. A system according to claim 31, further comprising:
program means for queuing forward messages in the order in which said forward messages are received via said telecommuications means, and
program means for regularly computing an average average headquarter processing time based on time elapsed between respective trasmissions of said forward and corresponding return messages; and
wherein said time-estimating program means includes an algorithm based on the number of forward messages in said queu and said average headquarter processing time.

33. A system according to claim 32, wherein said sales-site computer terminal is adapted to display a table in a minimized window on said sales-site monitor screen, said table containing status information including said elapsed time associated with each application for which a forward message was sent and a return message is awaited.

34. A system according to claim 33, wherein said table includes colour codes and said sales-site computer terminal is adapted to change a colour code of a said application in response to said elapsed time associated therewith exceding at least one predetermined threshhold.

35. A system according to claim 32, further comprising program means for comparing elapsed times against at least one predetermined threshhold and opening a window on said headquarters monitor screen to display status information on the assosciated credit application each time a said elapsed time exceeds said at least one predetermined threshhold.

36. A system according to claim 30, wherein said telecommunications means is further linked to a data-base containing defaulter identity information, said system further comprising means for looking up said data-base using said entered applicant identity and returning a credit rejection message in the event said identity is found in said data-base.
